(19) United States
(12) Patent Application Publication
(10) Pub. No.: US 2014/0224715 A1
(43) Pub. Date: Aug. 14, 2014

(54) SYSTEM AND METHOD FOR TREATING CONTAMINATED WASTEWATER

(71) Applicant: DALECO RESOURCES CORPORATION, West Chester, PA (US)

(72) Inventors: Michael Parrish, West Chester, PA (US); Gary Novinski, West Chester, PA (US)

(21) Appl. No.: 14/179,741

(22) Filed: Feb. 13, 2014

Related U.S. Application Data
(60) Provisional application No. 61/764,371, filed on Feb. 13, 2013.
(60) Provisional application No. 61/764,379, filed on Feb. 13, 2013.

(51) Int. Cl. C02F 1/00; C02F 1/28

(52) U.S. Cl. CPC C02F 1/008; C02F 1/281; C02F 2103/10
USPC 210/96.1

(57) ABSTRACT

A system, and method for removing contaminants from wastewater is disclosed. The system may include a first tank of a plurality of tanks containing zeolite material selected to capture and retain contaminants in the wastewater to produce treated water. At least one sensor associated with the first tank may be configured to detect a concentration of contaminants in the treated water. A control means is communicatively coupled to the at least one sensor, and is configured to direct the flow of the produced water to a second tank of the plurality of tanks based on the detected concentration of the treated water.

### CROSS-REFERENCE TO RELATED APPLICATION

This application claims priority to U.S. Provisional Patent Application Ser. No. 61/764,371, filed Feb. 13, 2014, entitled “System and Method for Treating Contaminated Wastewater”, and to U.S. Provisional Patent Application Ser. No. 61/764,379, filed Feb. 13, 2014, entitled “System and Method for Treating Contaminated Wastewater,” the entireties of which are incorporated by reference herein as if set forth herein.

### FIELD OF THE INVENTION

The instant disclosure relates to a system and method for applying a zeolitic material useful for converting a contaminated waste material that is environmentally unacceptable, to a relatively harmless substance which is environmentally acceptable, and, more particularly, applying a material with an effective amount of zeolite for treating waste water.

### BACKGROUND OF THE INVENTION

All industrial societies are faced with significant environmental problems associated with industrial waste water, many of which problems are hazardous to both animal and plant life. Examples of such wastewater include materials comprising sludges which settle as sedimentation layers at the bottom of the sea, lakes, and rivers; effluent sludges discharged from various industries including pharmaceutical, tanning, paper and pulp manufacturing, wool washing, fermenting, food processing, metal surface processing, plating, ore dressing, coal washing, and fume desulfuriing; as well as other wastes such as sewage sludges discharged from sewage processing stations, and those resulting from the refining of petroleum products. Such wastes are often contaminated with substances which can have an adverse effect on the ecological system.

The treatment and handling of such contaminated materials in wastewater, many of which can be classified as hazardous, are strictly regulated by one or more governmental agencies because of the potential harm to the public welfare. As such, a great deal of work has been done in recent years in developing methods for safely handling these materials and for neutralizing their troublesome characteristics.

Although a significant amount of work has already been done to treat contaminated wastewater, there is still a considerable need for improved methods for treating and neutralizing such materials.

### SUMMARY OF THE INVENTION

A system and method for removing contaminants from wastewater is disclosed. The system and method may include a first tank of a plurality of tanks containing zeolite material selected to capture and retain contaminants in the wastewater to produce treated water. At least one sensor associated with the first tank may be configured to detect a concentration of contaminants in the treated water. The system and method may also include a control means communicatively coupled to the at least one sensor. The control means may be configured to direct the flow of the treated water to a second tank of the plurality of tanks based on the detected concentration of the treated water. The treated water may then be further treated with zeolite material in the second tank, and so on. Similarly, treated water within acceptable parameters may be released from the network of tanks upon reaching the acceptable parameters.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a system for treating wastewater; and

FIG. 2 illustrates a method for treating wastewater, gas, and soil.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical waste treatment systems, processes, and materials. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Embodiments of the present disclosure are directed to a method and system for converting a contaminated waste material that is environmentally unacceptable. to a relatively harmless substance which is environmentally acceptable, and, more particularly, applying a material with an effective amount of zeolite for treating waste water. Contaminated waste may stem from a variety of sources and processes. One process that may lead to the contamination of water is hydraulic fracturing. Hydraulic fracturing, also known as “fracking,” is a technique used to spur oil and natural gas production.

The fracking process occurs after a well has been drilled and steel pipe casing has been inserted in the well bore. The casing may be cemented or uncemented. In horizontal hydraulic fracturing, cement (e.g., portland cement) may be used as casing. However, after drilling horizontally for extended periods, the cement may break down. Due to its porous nature, the cement is prone to outgassing. To prevent such break downs and outgassing, zeolite may be added to the cement mixture, producing a higher-strength cement with greater resistance to compression than the Portland cement. Further, the zeolite additive aids in the prevention of spreading contaminated waters. The casing may be perforated within the target zones that contain oil or gas, so that when the fracturing fluid is injected into the well it flows through the perforations into the target zones. Eventually, the target formation will not be able to absorb the fluid as quickly as it is being injected. At this point, the pressure created causes the formation to crack or fracture. Once the fractures have been created, injection ceases and the fracturing fluids begin to flow back to the surface. Materials called proppants (e.g., usually sand (which may advantageously be coated with zeolite or reagent material such as described in U.S. Pat. No. 5,387,738) or ceramic beads), which were injected as part of a frac fluid mixture, remain in the target formation to hold open the fractures.

Typically, a mixture of water, proppants and chemicals is pumped into the rock or coal formation. There are, however, other ways to fracture wells. Sometimes fractures are created by injecting gases such as propane or nitrogen, and sometimes acidizing occurs simultaneously with fracturing. Acidizing involves pumping acid (usually hydrochloric acid), into the formation to dissolve some of the rock material to clean out pores and enable gas and fluid to flows more readily into the well.

The fluids that come back out of a well after it has been hydraulically fractured may be of two types, 1) frac-flowback water, and 2) formation or produced water. Frac-flowback water is water that is returned to the surface from the well drilling and fracturing process. The flowback fluid is similar in composition to, though not exactly the same as, the fluid pumped down a well to fracture it and may contain substances such as flowback fracturing sand and other fracturing additives and chemicals. These fracking fluids may contain chemicals that may potentially be toxic, including petroleum distillates such as kerosene and diesel fuel (which contain boron, benzene, ethylbenzene, toluene, xylene, naphthalene and other chemicals); polycyclic aromatic hydrocarbons; methanol; formaldehyde; ethylene glycol; glycol ethers; hydrochloric acid; and sodium hydroxide.

Formation water, or produced water, is the water from joints and pores in the Marcellus Shale formation itself. It was present before drilling and is removed from the geologic formation to allow efficient natural gas production from the well. Produced water is generated on an ongoing basis over the productive life of the well and contains a variety of naturally-occurring contaminants, including heavy metals, naturally occurring radioactive material, volatile organic compounds, and high levels of total dissolved solids.

Treatment of this wastewater (frac, produced, or otherwise) may include passing the wastewater through a primary treatment system, a secondary treatment system, and a disinfection system to produce potable water and clean effluent. During the secondary treatment process, the wastewater may be subjected to biological processes to produce water, carbon dioxide and sludge. These processes include, but are not limited to, a waste activated sludge process, sequence batch reactor process (SBR), and the like. All of these processes produce sludge that may be further processed to biosolids.

The sludge may be transported to a solids treatment system to be reduced to biosolids. A water content of the sludge may be reduced so that the biosolids can be converted into recoverable energy (e.g. burned) and/or recycled (e.g. biosolids may be recycled into landscaping, gardening, soil improvement, land reclamation, forestry and/or agriculture processes). As a design, the sludge may be also be treated with a reagent material, such as described in U.S. Pat. No. 5,387,738, the entire contents of which are incorporated herein by reference.

Many improvements to wastewater treatment may be envisioned which may be employed in various stages of the treatment. Some of these improvements may be made during the activated sludge or SBR process.

The SBR process employs a number of discrete steps comprising the sequential fill, reaction, settlement and decantation of wastewater with biomass in an enclosed reactor. In the initial step of this process, wastewater is transferred into a reactor containing biomass, and combined to form a mixed liquor. In the reaction step of the treatment process, the microorganisms of the biomass utilize and metabolize and/or take up the nitrogen, phosphorous and organic sources in the wastewater. These latter reactions may be performed under anaerobic conditions, anoxic conditions, aerobic conditions, or a combination thereof.

Following the reaction cycle, the biomass in the mixed liquor is allowed to settle out. The treated and clarified wastewater (i.e. effluent) is subsequently decanted and discharged. The reactor vessel is then refilled and the treatment process cycle reinitiated.

For optimal treatment of wastewater, the rate of inflow of wastewater may need to be relatively consistent. However, wastewater generated at different types of sites may create vastly different flow characteristics. For example, wastewater generated at cottages, or other sporadic or seasonally lived-in communities, is markedly different from that of a permanent residence due to the highly intermittent or sporadic generation and flow of wastewater.

These variations may give rise to operating problems as well as process inefficiencies. Any agent or combination of agents that can improve or expand the range of the operation band for batch type plants, as well as for flow through plants, will relax the operating requirements as well as compliance excursions with effluent standards as well as being cost effective.

As such, in a design, zeolites may be employed to improve wastewater treatment performance. In particular, the zeolite material may be dispersed in a sequencing batch reactor or the bioreactors of a conventional flow through an activated sludge process. This zeolitic material may be of a type from Daleco Resources Corporation, such as described and claimed in U.S. Pat. No. 5,387,738, incorporated herein by reference. The zeolitic material may be employed in the SBR process as described and claimed in U.S. Pat. No. 7,452,468, also incorporated herein by reference. To evaluate the performance of the SBR treatment, samples may be taken at various steps of the processes. To effectively attain these samples for proper evaluation of the performance of the SBR processes, synchronized sampling, without operator attendance, such as described and claimed in U.S. Pat. No. 6,697,740, incorporated herein by reference, may be employed.

As referred to herein above, the treated and clarified wastewater (i.e. effluent) is subsequently decanted and discharged. However, this effluent may still not effectively be free of contaminants, or may not be free to the degree necessary to meet safety standards. Accordingly, there is a need to employ further treatment to the effluent to sufficiently rid the effluent of contaminants described above.

Embodiments of the present invention are directed to a system employing a reagent material including the afore-discussed zeolitic material for treating contaminating water. The reagent material, by weight, may be comprised of: (i) 1 part alumina; (ii) 1 to 3 parts, preferably 1.5 to 2.5 parts silica; (iii) 0.5 to 3 parts, preferably 1 to 2 parts of a hydroxide, or hydroxide precursor, of an alkali metal; (iv) 2 to 5 parts, preferably from about 2.5 to 3.5 parts of CₐO; (v) and 2 to 5 parts, preferably from about 2.5 to 3.5 parts of a zeolitic material. It is also preferred that the silica material have a surface area of at least about 10 m²/g, preferably at least about 50 m²/g. The preferred hydroxide is NaOH. It is understood that hydroxide precursor materials may also be used. Non-limiting examples of NaOH precursors include Na₂O, NaAlO₂, and Na₂O(SiO₂)ₓ. Preferred zeolitic materials are those having an average pore diameter equal to or greater than 4 Angstroms preferably equal to or greater than 5 Angstroms. The more preferred are zeolitic materials which are iso-structural to a zeolite selected from clinoptilolite and chabazite. It is also understood that precursors of both alumina and silica may be used. For example, bauxite, kaolin, NaAlO₂, and Al₂O₃3H₂O are preferred materials for the alumina component of the reagent material of this invention. Preferred silica materials include: silica gel, silica smoke, volcanic ash, kaolin, and sodium silicate (water glass).

Certified laboratory testing has proven that the reagent material can transform the following hazardous materials from a hazardous or toxic state to a non-hazardous, or non-toxic state: anthracene, hexachlorobutene, benzene, methoxychlor, carbontetrachloride, methylethylketone, chlordane, nitrobenzene, chlorobenzene, pentachlorophenol, chloroform, phenol creosol, pyrene, chrysene, pyridine, cyanide, tetrachloroethylene2-4-D, toluene, dichlorobenzene, toxaphene, dichloroethane, trichloroethylene, dichloroethylene 2-4-5, trichlorophenol, dinitrotoluene 2-4-5, TP (Silvex) endrin, vinyl chloride, heptachlor, xylene, and hexachlorobenzene. Certified laboratory testing has also proven that the reagent material can transform the following metals or metallic compounds from a hazardous or toxic state to non-hazardous or non-toxic state: arsenic, lead, barium, mercury, cadmium, nickel, cesium, silver, chromium, and strontium.

The reagent material of the present invention, which will typically be in particulate or granular form, is used by mixing an effective amount of it with the wastewater. The following examples using the reagent material are presented for illustrative purposes only and should not be taken as limiting the present invention in any way.

### Example 1

A 100 gram sample of contaminated soil from a site in Mexico was treated with 100 grams of the reagent mixture as described above. Analysis of the treated and untreated samples are given in Table 1 below:

| Analysis | As received | Treated |
|---|---|---|
| Total volatile petroleum | 3,600 | <5 |
| hydrocarbons (mg/Kg) | | |
| Total Extractable Petroleum | 32,000 | 25 |
| hydrocarbons (mg/Kg) | | |
| BTEX Analysis (ug/Kg) | | |
| Benzene | <500 | 26 |
| Toluene | 570 | 67 |
| Ethylbenzene | 10,000 | 5.3 |
| Xylenes | 68,000 | 28 |
| Organic Lead (mg/Kg) | 1.0 | <0.3 |

### Example 2

A 100 gram sample of contaminated soil from Chemical Pollution Control of New York, N.Y., was treated with 100 grams of the reagent material as described above. Analysis of the treated and untreated samples is given in Table 2 below:

| Analysis | As received | Treated |
|---|---|---|
| Total volatile petroleum | 22,000 | 23 |
| hydrocarbons (mg/Kg) | | |
| Total Extractable Petroleum | 23,000 | 410 |
| hydrocarbons (mg/Kg) | | |
| BTEX Analysis (ug/Kg) | | |
| Benzene | 47,000 | <50 |
| Toluene | 1,100,000 | 820 |
| Ethyl benzene | 370,000 | 350 |
| Xylenes | 2,700,000 | 2,500 |

In yet a third example, a sample of material contaminated with lead, Hg, and arsenic was treated with a zeolitic material. In a first pass, 60% of lead was captured by the zeolitic material, and 80% was captured in the second pass.

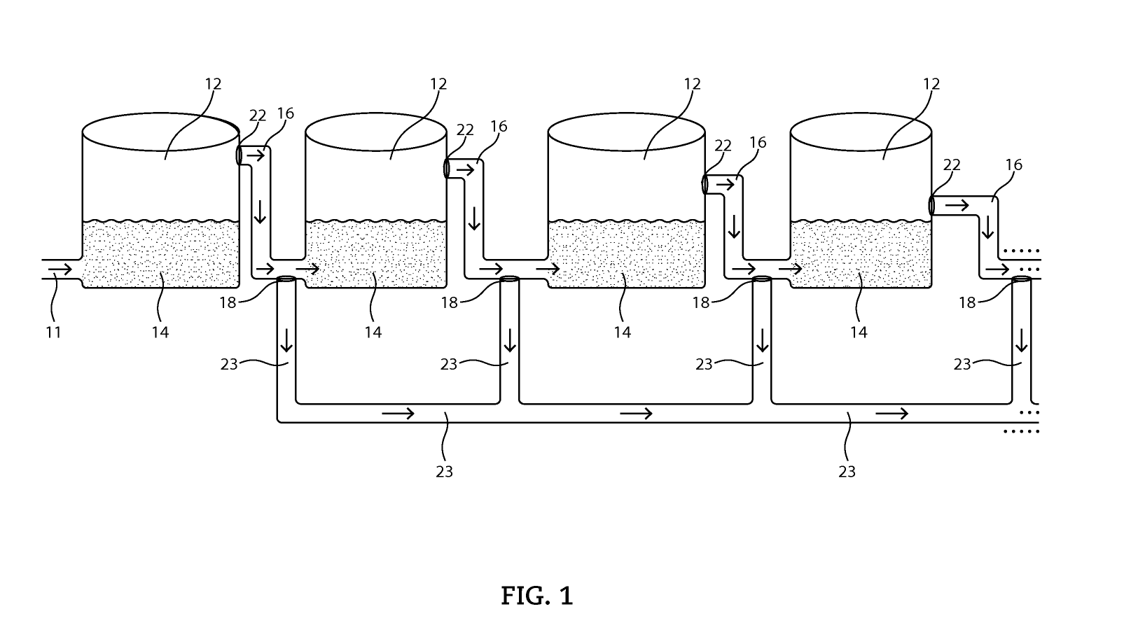

FIG. 1 illustrates a wastewater treatment system 10 comprising a series of tanks 12, each containing a bed of reagent material 14. Those skilled in the art will appreciate, in light of the discussion herein, that simple zeolitic material rather than the more complex reagent material 14 may be used in certain embodiments for the treatment of certain contaminants and contaminated substances.

The tanks 12 are connected by pipes 16. To easily allow for water to naturally flow from one tank to a subsequent tank, each subsequent pipe 16 may be affixed at a lower position at the rear end of the tank 12 than the pipe 16 affixed to the front end of the same tank 12. Each pipe 16 may house a release valve 18 for releasing decontaminated water from the system through a bypass pipe 23. A sensor 22 may be placed in each of the tanks 12, or at a front end of each of the pipes 16, such as to detect the concentration of contaminants (e.g. Boron) in the mixed water entering each of the pipes 16. The sensor 22 may comprise any type of sensor suitable to detect the concentration of any contaminants in the water. By way of non-limiting example only, the sensor 22 may be an ion sensor configured to detect the concentration of Boron by measurement of the Boron ion concentration level generally through measurement of the electrical conductivity of the wastewater entering the pipe 16. The release valves 18 may be solenoid-operated valves, which may receive electrical signals from the sensors 22, and/or from a control means, e.g. a programmable logic controller (not shown), to control the opening and closing of the release valves 18.

In operation of system 10, wastewater flows into the system 10 through an entry pipe 11 to be mixed with a bed of reagent material 14 in the tank 12. The wastewater flowing into the system 10 may be transported from another wastewater treatment facility, directly from a hydraulic fracturing site, or may be from any water source. Because of the continuing wastewater flowing into tank 12, the level of the liquid in the tank 12 may rise to the associated pipe 16 on the opposite end of the tank 12. It should be noted that, in the event a level of liquid in any given tank 12 (due to, for example, a lack of continuous water flow) fails to rise to the height of the affixed pipe 20, a pump (not shown) may be employed to ensure the liquid circulates and continues to flow through the system 10. Towards the rear end of each tank 12, the sensor 22 may detect the concentration of the contaminants in the liquid. If the detected concentration of the water is at a safe level, the sensor 22 transmits a signal to open the release valve 18, allowing the decontaminated water to flow out of the system 10 through the bypass pipe 23. Alternatively, if the detected concentration of the water entering pipe 16 remains at an unsafe level, the release valve 18 will remain closed, and the water (still having unacceptable levels of contaminants) may flow (either valved or unvalved) into the next tank 12 to be further treated with more reagent material 14 as was done in the preceding tank 12. After being further treated in a subsequent tank 12, the toxicity of the water is again detected by the sensor, and, based on the concentration of contaminants, the valve will open/close allowing water to flow into a subsequent tank for treatment, or be released from the system. For the sake of simplicity, four tanks are shown. However, any number of tanks, sensors, and conduits may be employed as needed to sufficiently decontaminate the wastewater.

After treatment from the system of FIG. 1, the water may or may not be potable. Accordingly, the water may subsequently be stabilized in the form by blending the water with zeolitic material, such as described and claimed in U.S. Pat. No. 5,387,738. A final rinse stage may be implemented during post treatment by rinsing the effluent in mobile H₂O units through the process of encapsulation.

Those skilled in the pertinent arts will appreciate, in light of this disclosure, that waste water, sludge, slurry, such as from wash plants in the form of a coal slurry, or the like may be serially decontaminated through the use of the present invention. For example, the coal slurry can be reprocessed, and blended with zeolite and water, and used as a fuel having a high BTU content. Further, those skilled in the art will further appreciate that contaminated gas may be similarly serially treated in a tank or container based system such as that illustrated in FIG. 1.

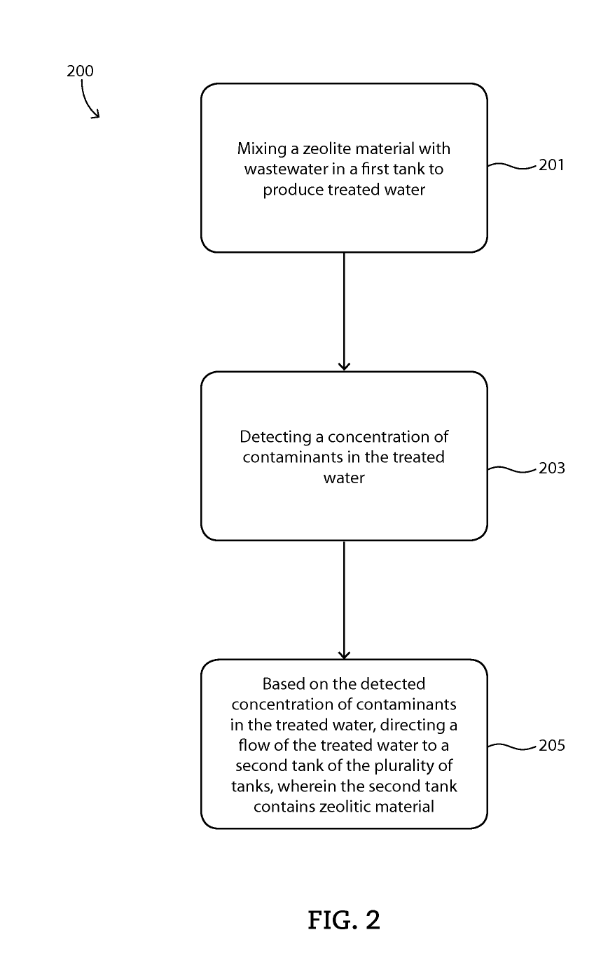

FIG. 2 illustrates a method 200 for treating wastewater according to embodiments of the present invention. Method 200 may include mixing a zeolitic material (or the afore-discussed reagent material, in some embodiments) with wastewater in a first tank of a plurality of tanks to produce treated water at step 201. Method 200 may further include detecting a concentration of contaminants in the wastewater at step 203. Method 200 may further include, at step 205, based on the detected concentration of contaminants in the treated water, directing a flow of the treated water to a second tank of the plurality of tanks, wherein the second tank contains zeolitic material. Optionally, method 200 may be used for treating gas and oil as well.

In addition to natural gas, a second major fossil fuel used to satisfy energy needs is coal. Among many other uses, coal is typically burned at power plants to generate electricity and results in multiple ash-based waste streams. Fly ash is comprised of the fine particles that rise with the flue gas and are subsequently removed from the flue gas through various separation processes. Depending on the source and makeup of the coal being burned, the components and nature of the fly ash that is generated can vary. All fly ash, however, includes substantial quantities of toxic substances.

In addition to the fly ash removed from the flue gas, bottom ash falls directly from the combustion process to the bottom of the burner. Presently, both of these coal combustion residues (CCR) are being disposed of primarily in unlined landfills or impoundments. Even though fly ash has not previously been regulated by the U.S. Environmental Protection agency (EPA) as a hazardous waste, community and environmental organizations have documented numerous environmental contamination and damage concerns arising from CCR. For example, CCR that have not been encapsulated and are currently stored in unlined landfills have been found to leach arsenic, mercury, lead, and other toxic heavy metals into groundwater. These coal combustion residues can similarly be treated with a mixture of the reagent material, such as that described in U.S. Pat. No. 5,387,738. Scrubbers can be also be used to trap these pollutants from going into the air from smoke stacks. Sometimes, pollutants such as SOₓ and NOₓ may be put back down smoke stacks and, consequently, increasing the ash concentration 1 fold. For example, this zeolitic material can be used in conjunction with air pollution control devices, like scrubbers for example, for the removal of. Likewise, these coal combustion residues may be suspended in a sludge, and accordingly treated by the system of FIG. 1 and/or the method of FIG. 2. Further, the sludge can be mixed with a zeolite material to neutralize the acidity or alkalinity of the sludge particles.

Embodiments of the present invention may also employ the use of zeolite or the reagent material described in U.S. Pat. No. 5,387,738 in animal husbandry, such as animal waste from piggeries, or hog lots. Piggeries are generally large warehouse-like buildings or barns. Indoor systems, especially stalls and pens (i.e., ‘dry,’ not straw-lined systems) allow for the easy collection of waste, through hog slats, for example. As used herein, slats are a type of flooring used in pens for animals, most typically in large-scale animal operations. They comprise regular gaps in the floor that allow excrement, spilled food and other waste products to be easily washed through to a lower level. The lower level is usually a shallow drainage trench, or cellar, leading to a retention pond, or lagoon. However, the waste smell remains a problem which is difficult to manage.

As used herein, a lagoon refers to an earthen basin filled with animal waste that undergoes anaerobic respiration as part of a system designed to manage and treat refuse created by Concentrated Animal Feeding Operations (CAFOs). Lagoons may be created from a manure slurry, which is washed out from underneath the animal pens and then piped into the lagoon. Sometimes the slurry is placed in an intermediary holding tank under or next to the barns before it is deposited in a lagoon. Once in the lagoon, the manure settles into two layers: solid, or sludge, layer and the liquid layer. The manure may then undergo the process of anaerobic respiration, whereby the volatile organic compounds are converted into carbon dioxide and methane. The sludge may be treated with the zeolite which can be useful for several purposes. The zeolitic material can be used to coat particles in the sludge to, in effect, create a time released fertilizer. Also, having zeolite in the stalls, (e.g., horse bedding), racetracks, and the like, aids in the prevention of hoof and mouth disease of many animals as it helps promote healthy hooves. Specifically, zeolitic material may be laid down in an animal stall for cleaning, and can absorb moisture and create a drier environment that reduces hoof problems.

Anaerobic lagoons have been shown to harbor and emit substances which can cause adverse environmental and health effects. One of the most prevalent emitted substances is ammonia, which may stem from the uric acid of the animal waste. The animal waste may also contain unsafe amounts of heavy metals such as arsenic, copper, selenium, zinc, cadmium, molybdenum, nickel, lead, iron, manganese, aluminum and boron. When it rains, the lagoon water, along with the animal waste, empties into streams. In a design, the reagent material having a composition as described in U.S. Pat. No. 5,387,738 is mixed with the animal waste to be treated to effectively remove these substances, and/or neutralize ammonia on the floor of the slats for example, or in the lagoon. Also, the zeolitic material discussed herein may be provided serially, such as in the exemplary embodiment of FIG. 1, to thereby allow for a serial decontamination of the animal waste. Likewise, the lagoon may be directly treated with simple zeolitic or reagent material.

Embodiments of the present invention may also employ the use of zeolitic reagent material to treat oil. This treatment may be especially effective in oil spills (e.g., in garages as an absorbent) which release liquid petroleum. It may be advantageous to employ zeolitic materials having an average pore diameter of approximately 4 Angstroms, which may be an effective size for the breaking down of hydrocarbons, by acting as a molecular sieve, acting as an absorbent and a flocculant on the oil. Specifically, hydrogen atoms may be able to fit through zeolite pores of 4 Angstroms, but carbon atoms may not. Again, the treatment of the oil spillage may be performed directly using simple zeolitic or reagent material, or may be performed on a sludge generated for serial treatment via a system similar to that shown in FIG. 1.

Embodiments of the present invention may also employ the use of zeolite as an additive to pelletized waste. Pelletizing waste is becoming a viable means of safe disposal as well as for fuel. Specifically, as an alternative to materials such as coal, oil, or natural gas, pelletized waste may be used for a variety of approved industrial applications (e.g., spreading over strip mines) and fertilizer.

Although fertilizer can be very beneficial to grass and other plants, over-fertilizing can have a severe impact on the environment, especially when the fertilizer is carried away by runoff. Nitrogen, among other elements can cause damage in standing bodies of water like lakes and ponds. Once there, the fertilizer has nowhere to go and feeds the plants and microorganisms that reside in the water. The growth rate of the plants and algae quickly exhausts the oxygen in the water, depriving fish and other species of oxygen and suffocating them. As the dead plants and fish decompose, the microorganisms feast on the remains, leading to another algae bloom. In some cases, this algae can be toxic. Further, pelletized waste emits an extremely unpleasant odor when hydrated, due mainly in part to its ammonia content and outgassing. In an embodiment, zeolite may be used as an additive to the pelletized waste to absorb the ammonia reducing outgassing and runoff (through, for example, controlling the release of nutrients), thus lessening the impact on the environment. By, in part, changing the composition of the ion exchange sites and by loading the sites with selected nutrient cations, zeolites can become an excellent plant growth medium, and can also line gulleys on a farm. Combined with slowly dissolving minerals (such as synthetic and/or natural nutrient anions), some zeolitic materials can supply plant roots with additional vital nutrient cations and anions, which can lead to a yield increasing four fold. Consequently, the zeolite blended pelletized waste may make an effective fertilizer or soil amendment (with lime for example), as the zeolitic material allows for better natural nitrate uptake of fertilizer into plants.

Similar benefits can be found through the use of the above described zeolitic material on spend mushroom compost. Spent mushroom compost may be described as the residual compost waste generated by the mushroom production industry. It is readily available (e.g., bagged, at nursery suppliers), and its formulation generally consists of a combination of wheat straw, dried blood, horse manure and ground chalk, composted together. After it no longer produces viable yields of mushrooms, it may be thrown out, or sold by mushroom farms, to be used as mulch. Unfortunately, at this point, this spent mushroom compost carries a pungent odor. This mushroom waste can be blended with the zeolitic material to eradicate the pungent odor, thus making the compost more tolerable as fertilizer and increasing plant yield.

Zeolitic material, such as that claimed and described in U.S. Pat. No. 5,387,738 can be an effective soil amendment due to over-fertilization of animal waste, such as from bovines. This over-fertilization can negatively impact the ability to sufficiently feed cows. For example, it takes roughly 10 acres of grass to feed one cow. As discussed above, over-fertilization can be detrimental to the soil, and, consequently in this case, making it more difficult to supply adequate land to feed cows. As such, the zeolitic material described above can be used to restore the soil effectively reversing the effects of over-fertilization.

Embodiments of the present invention can also be employed to decrease the methane emissions, and thus, reduce the harm inflicted on forests. In particular, most of greenhouse gas emissions are in the form of methane released from animals' digestive systems. As such, zeolitic material may be added to feedstock for animals to produce less gas by, in part, breaking down ammonia and methane and pulling off hydrogen.

Besides the impacts of methane gas, ammonia, found in chicken excrement, may also present problems, especially to chickens, as many chickens die from ammonia poisoning. Due to its extreme odor, ammonia gas a high concentrations is irritating to mucous membranes of the respiratory tract and the conjunctivae and corneas of the eyes. Damage to the mucous membranes of the respiratory system increases the susceptibility of birds to bacterial respiratory infection. High levels of ammonia also have a negative impact on overall livability, weight gain, feed conversion, condemnation rate at processing and the immune system of the birds. Similar to implementation on methane, the zeolitic material may be blended with the chicken excrement to treat the ammonia and capture nutrients from the waste and create an effective organic fertilizer, which can result in improved growth, and alleviate the pungent odor due to the ammonia.

Further embodiments of the present invention may employ the use of zeolite, or the above described zeolitic material in bandages. Particularly, zeolite, due to its absorbent qualities, can absorb water from blood, which encourages blood clotting and reduces blood loss. Also, the zeolite can absorb any contaminants, reducing the chances of wound infection.

Embodiments of the present invention can also be used to remove toxins in the human body. Specifically, human bodies may not successfully remove all the toxins entering our body as quickly as necessary. Consequently, the body automatically starts to put these metals and toxins in the place of storage in the body, such as deposits in tissues, and even our bones. These substances are known to contribute to many adverse health problems, including cancer and heart disease. Due to its high ion exchange capacity, zeolites may be used to attact, trap, and remove these toxins and metals from bodies. These zeolitic materials may be administered in many ways, for example, in pill form, or in food.

The zeolitic material as described above, may be also be an effective building material. All natural products, especially stone, minerals, and sand, contain trace amounts of some radioactive elements called NORMs (Naturally Occurring Radioactive Mineral) that can produce measurable amounts of radiation and sometimes radon gas. Zeolitic material may act as an effective absorbent to absorb these NORMs which may be found in traditional building materials.

Embodiments of the present invention may also be effective in immobilizing radioactive wastes. Zeolitic material such as described in U.S. Pat. No. 5,387,738 may be employed in separations of long-lived Cs and Sr radioisotopes. These radioisotopes can also be retained on zeolites for long-term storage by ion exchange onto the zeolite, drying the zeolite to prevent excessive pressure after the container is sealed, and sealing the containers by welding. Since zeolites contain alkali metal or alkaline earth oxides, alumina and silica (major constituents of many common glasses), heating to temperatures sufficient to cause destruction of the zeolite crystal structure can convert the zeolite to a glass. Addition of suitable flux calcining agent can allow this to be accomplished at lower temperatures. Leach rates for alkali and alkaline-earth elements from aluminosilicate glasses are extremely low (e.g., 10⁻⁷ gm/cm²-day). The chemical durability, low leach rates, and high thermal conductivity of glass combine to make this an ideal form for immobilizing radioactive wastes.

Yet still further embodiments of the present invention may employ the use of zeolites in the processing of kaolin, a valuable mineral known for many applications (for example, ceramics, tooth paste, light bulbs, cosmetics, organic farming, etc.) Due to its uniform porous nature, zeolitic materials as described in U.S. Pat. No. 5,387,738 may be used as a proppant for the processing of kaolin, creating better permeability. Further, embodiments facilitate the production of additional layers of kaolin which, for example, may be used in concrete can create a strong, earthquake resistant, cement.

Embodiments of the present invention can also be used to repair reefs in underwater environments. Reefs are mainly composed of calcium carbonate. Holes in reefs may expose sensitive material of the reef, and, unfortunately, excessive exposure may cause reefs to die. Specifically, the zeolitic material may be placed inside a wire mesh (e.g., chicken wire) to act as a cofferdam, and along with travertine, can be used to repair the calcium carbonate of the reef. Further, the zeolitic material, in great amounts, can be used to seed a reef.

Embodiments of the present invention may also be applicable to acid mine drainage, and, in particular, potential byproducts of, acid mine drainage. Acid mine drainage (AMD), or acid rock drainage (ARD), refers to the outflow of acidic water from (usually abandoned) metalmines or coal mines. However, other areas where the earth has been disturbed (e.g. construction sites, subdivisions, transportation corridors, etc.) may also contribute acid rock drainage to the environment. In many localities the liquid that drains from coal stocks, coal handling facilities, coal washeries, and even coal waste tips can be highly acidic, and in such cases it is treated as acid rock drainage. Acid rock drainage occurs naturally within some environments as part of the rock weathering process but is exacerbated by large-scale earth disturbances characteristic of mining and other large construction activities, usually within rocks containing an abundance of sulfide minerals, one of which is iron pyrite, or “fools gold”. Embodiments of the present invention can be used to efficiently gather large amounts of calcium carbonate from the iron pyrite. In particular, in conjunction with an auger, the calcium carbonate can be introduced to a series of downstream dams composed of zeolitic material to accumulate the calcium carbonate. This calcium carbonate can be sold and used as feedstock for bricks.

In addition to the substances address above, of course, one of ordinary skill in the art will recognize that simple zeolitic and/or reagent material as is described hereinthroughout may be used on other types of contaminated substances, and via other treatment methodologies, as well. For example, the zeolite and/or reagent material may be employed for the removal of ammonium and phosphorous from municipal wastewater (followed by use of the by-product as fertilizer), such as by direct application and/or via the system of FIG. 1 and the method of FIG. 2; the removal of metals from drinking, waste, and industrial water, such as by direct application and/or via the system of FIG. 1 and the method of FIG. 2; the removal of calcium from household tap water, such as by direct application and/or via the system of FIG. 1 and the method of FIG. 2; the removal of trichloroethylene from underground household water, such as by direct application and/or via the system of FIG. 1 and the method of FIG. 2; the removal and recovery of heavy metals from acid rock drainage, such as by direct application and/or via the system of FIG. 1 and the method of FIG. 2; the removal of water and carbon dioxide from select petroleum hydrocarbons, such as by direct application and/or via the system of FIG. 1 and the method of FIG. 2; the removal of sulfur dioxide and arsenic gasses from smokestack emissions at power and chemical plants, such as by direct application and/or via the system of FIG. 1 and the method of FIG. 2; the removal of hydrogen sulfide, carbon dioxide, and water vapor from natural gas, such as by direct application and/or via the system of FIG. 1 and the method of FIG. 2; the removal of radioactive contamination created by radionuclides Cesium 137 and Strontium 90 from soil and water, and animal feed (e.g. Chernobyl, Russia), such as by direct application and/or via the system of FIG. 1 and the method of FIG. 2; the improvement of growth and feed utilization, reduction of incidences and severity of diarrhea, and the reduction of odors from animal waste when added to animal feed; and the removal of toxic ammonia from fish tanks and fish hatcheries, such as by direct application and/or via the system of FIG. 1 and the method of FIG. 2.

For example, with respect to the removal of ammonia from fish environments, zeolite material, for its great ion exchange capacity, may be desirable as a secondary or backup system to biological filters for use in aquaculture systems. For example, a portion, or chunk of zeolite may be placed in a fish environment (e.g., koi ponds). Oxygen may be released from the pores of the zeolite, which may result in a removal of ammonia, which may be toxic to fish.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A system for removing contaminants from wastewater, the system comprising:
a first tank of a plurality of tanks containing zeolitic material to remove contaminants from the wastewater passing through the first tank, to thereby produce treated water;
at least one sensor associated with the first tank and configured to detect a concentration of the contaminants in the treated water; and
a control means communicatively coupled to the at least one sensor, the control means configured to direct the flow of the treated water to a second tank of the plurality of tanks based on the detected concentration of the treated water; wherein the treated water is further treated with zeolitic material in the second tank.

2. The system of claim 1, wherein the plurality of tanks equals less than four tanks.

3. The system of claim 1, wherein the plurality of tanks equals less than three tanks.

4. The system of claim 1, wherein the wastewater comprises coal combustion residues.

5. The system of claim 1, wherein the wastewater comprises hydraulic fracturing residue.

6. The system of claim 1, wherein at least one of the plurality of tanks comprises at least one pump.

7. The system of claim 1, wherein the flow of the treated water is diverted by the control means when a predetermined concentration of the contaminants in the treated water.
